(19) United States
(12) Patent Application Publication
(10) Pub. No.: US 2009/0199320 A1
(43) Pub. Date: Aug. 13, 2009

(54) Seamless headwear and a method of manufacture for the same

(76) Inventor: Louis Yum Ming Ng, Kwun Tong (CN)

Correspondence Address: Allan Chan, Suite 700, 225 Broadway, New York, NY, 10007, US

(21) Appl. No.: 12/069,487

(22) Filed: Feb. 10, 2008

(51) Int. Cl. A42C 5/04; A42B 1/00; B29C 65/08; B29C 65/00

(52) U.S. Cl. 2/209.3; 2/195.1; 2/209.5; 156/73.1; 156/1

(57) ABSTRACT

A seamless hat and a method manufacturing in which cloth material is cut to form cut-out pieces having specific pattern outlines, then, after affixing superimposed edges of the cut-out pieces, then fixedly joined by ultrasonic or high frequency equipment is used to administer bonding processing. The current invention is not limited to the type of hat or specific type of materials. The preferred embodiment of the current invention involves producing highly ventilated piece of headwear. Additionally, said invention may be unnoticeably light weight to the wearer for entirely more comfortable experience.

### BACKGROUND OF THE INVENTION

The present invention relates to a manufacturing method and apparatus for a seamless hat in which large portions of the manufacturing may require reduced or eliminate stitches to stitch a hat during the machining process, whereby the heat fusing property of ultrasonic and high frequency wave processing is adopted to fuse fiber cloth material of a hat body of the hat to join together edges of the hat.

### SUMMARY OF THE INVENTION

The primary objective of the present invention is to provide a manufacturing method and apparatus of a seamless hat that enables fabricating a hat with an outward appearance free from stitches, in turn producing a finalized product which is lighter in weight due to the reduced or lack of stitches.

Another objective of the present invention is to provide the manufacturing method for a seamless hat that enables fabricating a hat free of stitches and form a three dimensional shape with multiple pieces of fabric resulting in a product which aesthetically appear to a product one continuous piece of fabric.

Yet another objective of the present invention is to provide a piece of headwear which is well ventilated to aerate the wearer if he/she is participating in sporting activities. Alternatively, said ventilation is not only used to aerate the head of the wear but also to release moisture which can be trapped by a conventional hat.

A seamless hat and a method manufacturing in which cloth material is cut to form cut-out pieces having specific pattern outlines, then, after affixing superimposed edges of the cut-out pieces, then fixedly joined by ultrasonic or high frequency equipment is used to administer bonding processing. The current invention is not limited to the type of hat or specific type of materials. The preferred embodiment of the current invention involves producing highly ventilated piece of headwear. Additionally, said invention may be unnoticeably light weight to the wearer for entirely more comfortable experience.

These and other features and aspects of the invention can be understood from the accompanying drawing figures and detailed description of certain disclosed embodiments.

### BRIEF DESCRIPTION OF THE DRAWINGS

FIG. 1 shows a front view depicting a hat according to the present invention as well as the location of the ultrasonic bonding of various panels.

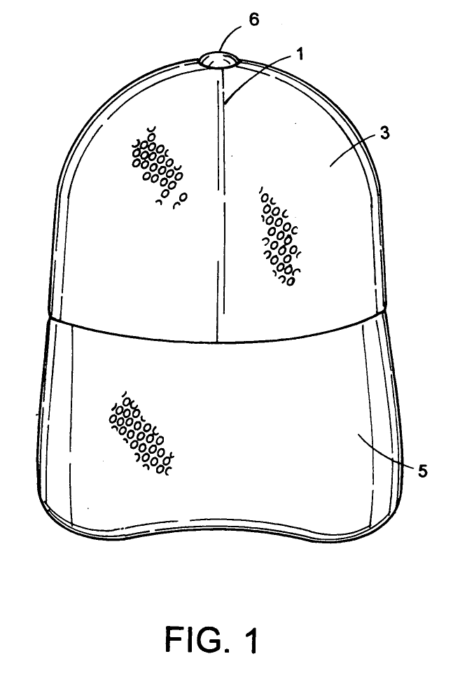

FIG. 2 shows a top view depicting the hat as well as the location of the ultrasonic bonding of various panels.

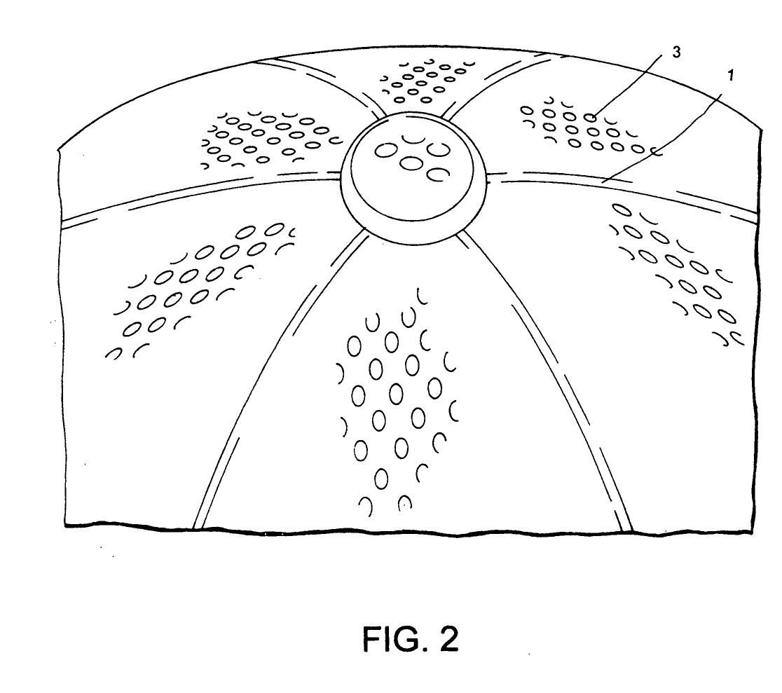

FIG. 3 shows an expanded top view depicting the hat as well as the location of the ultrasonic bonding of various panels.

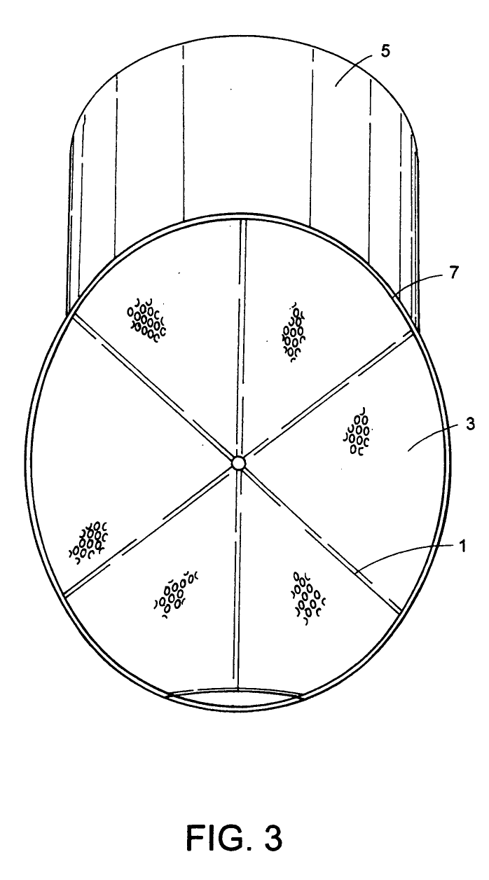

FIG. 4 shows a side view depicting a hat according to the present invention as well as the location of the ultrasonic bonding of various panels with at least one solid panel.

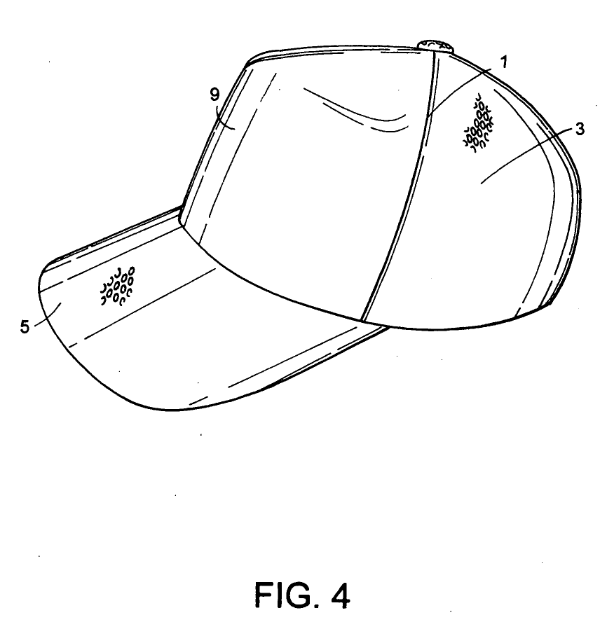

FIG. 5 shows an expanded top view depicting the hat as well as the location of the ultrasonic bonding of various panels with at least one solid panel.

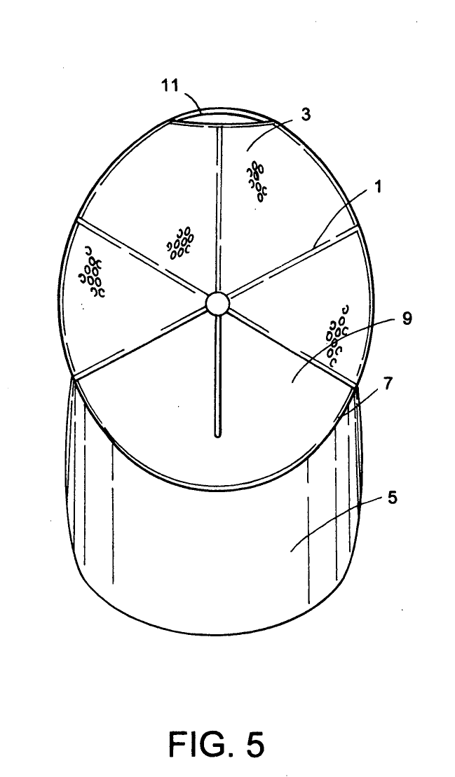

FIG. 6 shows a top view depicting the hat as well as the location of the ultrasonic bonding of various panels with at least one solid panel.

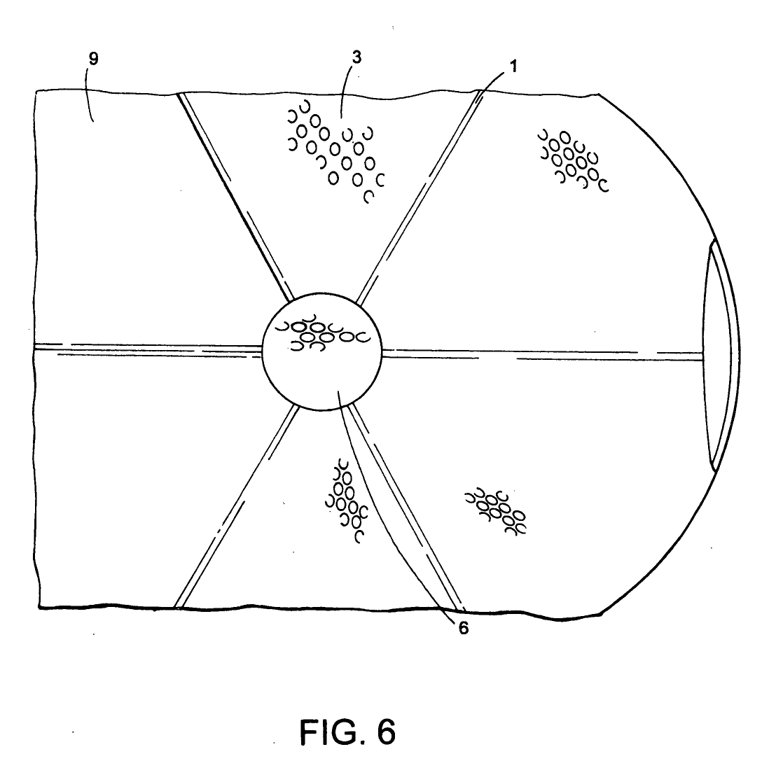

FIG. 7 shows a back view depicting the hat with adjustability to suit a wearer with any head size.

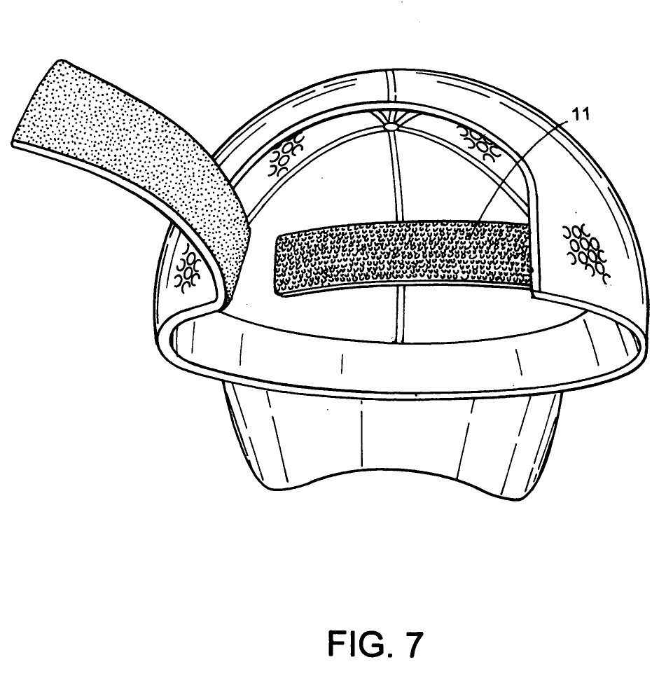

### DETAILED DESCRIPTION OF THE PREFERRED EMBODIMENTS

One embodiment of the current invention is in the form of a baseball cap however the current invention is not limited to any form of headwear.

In the preferred embodiment, the crown is made up of a plurality of triangular or pie-shaped panel pieces 3 of material such as polyester, nylon, synthetic materials, cotton, or wool. The preferred embodiment of the invention is constructed with polyester or nylon fabric materials but the invention is not limited to such materials. With one or more exceptions the triangular crown panels 3 are ultrasonically bonded together, with the tips of the triangular pieces defining an apex, which is typically hidden by a button 6 as shown. The bottoms of the triangular pieces define the circumferential portion of the hat.

In the preferred embodiment of the invention, tapping is not used. Two pieces of pre-cut fabric panel pieces 3 are laid side by side, and about 2 mm of edge width on each panel overlapping each other guided by an attachment (not shown). At the same time, the ultrasonic machine laminates two pieces fabric material together. No cutting by the ultrasonic machine is required and two pieces are joined together in the ultrasonic bonding process. The ultrasonic bonding process produces a tracking line 1 without a seam or separation. The resulting hat, with multiple panel pieces appearing to be formed with a continuous piece of material.

In the preferred embodiment, ventilation of the current invention is achieved with mesh formed panels 3. Said mesh panel may be comprised of multiple layers of varying mesh configurations. Ideally the inner layer, a finer mesh layer is positioned closest to the wearer. The mesh with larger pores forms the outer layer. The purpose of the multiple layers facilitates greater aeration of the wearer. Furthermore, the multiple layers facilitates the evaporation of moisture.

In the preferred embodiment, a visor or brim 5 is frontally mounted by similarly ultrasonic fusing or stitched on the present invention along the lower periphery of the hat, the circumferential portion of the hat. The visor or brim 5 is ideally suited to protect the wearer's face (not shown) against the ravages of sun, wind, rain, snow, ice, and other atmospheric conditions.

After completing the hat body, a bottom edge of the hat, lower periphery of the hat, the circumferential portion of the hat body is similarly fuse joined or stitched to the hat brim, sweatband liner, or a decorative band, thereby completing fabrication of the hat.

Additionally, the current invention which utilizes little to no stitches greatly reduces the physical weight of the hat.

Alternate embodiments of ultrasonic bonding techniques as known to persons in the art may also be used. It is an object of the invention to provide a method for bonding any seams of synthetic fabric in a manner that does not result in holes, which holes impair the protective qualities of protective garments made from such synthetic fabric.

It is further object of this invention to provide an efficient method of binding together the closing seam of a part of such protective garment, such closing seams presenting special problems which are solved by the present invention.

Briefly, but not by way of limitation, the present invention provides a method for bonding overlapping edges of parts of garments, as opposed to congruent edges, using ultrasonically bondable fabric. The bond thus obtained is very strong and is adequately resistant to shearing stresses, thus eliminating the need for stitching to strengthen the seam against possible shearing. While a single seam is ordinarily edges along their respective extremities.

It is found that ultrasonic bonding will occur between the overlapping edges where laminated and unlaminated sides are in contact with each other, but that little or no ultrasonic bonding occurs between the folded-under fabric and either of the overlapping edges where unlaminated sides only are in contact with each other. To the extent any slight bonding takes places between the unlaminated surfaces, a slight shearing force can be applied which unfolds the folded-under portion, without in any way disturbing the secure bond achieved between the overlapping edges which it was the purpose of the invention to produce. This very satisfactorily closes the seam ultrasonically which otherwise would be difficult or impossible to do.

The ultrasonic bonded fabric is shown with the ultrasonic wheel and cutting assembly in a top view which is partially sectional. The ultrasonic cutting wheel may also be used in connection with the bonding teeth wheels. A fabric positioning and cooling wheels also assembled fashion with the teeth wheels and cutting wheel.

A method of forming a seam between fabric pieces is provided. For example, the method includes providing a first fabric piece and a second fabric piece. Each fabric piece has an upper surface and a lower surface that define at least one edge.

A first tape portion is placed adjacent to the first fabric piece such that the tape portion is placed in operative communication with the upper and lower surfaces of the first fabric piece. Further, a second tape portion is placed adjacent to the second fabric piece such that the second tape portion is placed in operative communication with the upper and lower surfaces of the second fabric piece. Each tape portion comprises a thermoplastic material that is melt-flowable when subjected to a certain amount of heat and pressure. For example, in one embodiment, the tape contains polyurethane.

In addition, the method also includes forming an adhesive bond and a physical bond between the first tape portion and the first fabric piece and between the second tape portion the second fabric piece. An “adhesive bond” generally refers to a bond that results from attractive forces between two or more materials. For instance, adhesive bonds may sometimes result from “dipole-dipole forces” between materials, which are a type of van der Waals force that occurs upon the interaction of the dipole moments of two polar molecules. In addition, a “physical bond” can refer to the physical intermingling of a material within the interstices of a fabric piece.

In some embodiments, the method can also include heating the first tape portion and/or the second tape portion to a certain predetermined temperature. For example, in some embodiments, the first tape portion and/or the second tape portion can be heated to a temperature of between about 10 degree C. below the thermal melting point of the thermoplastic material to about 50 degree C. above the thermoplastic material. Besides being heated, the first and/or second tape portions can also be subjected to a certain pressure. For example, in some embodiments, the first and/or second tape portions can be subjected to a pressure of between about 40 pounds per square inch to about 120 pounds per square inch.

If desired, the tape portions may also be folded or shaped before and/or after being placed adjacent to the first and second fabric pieces. For example, in one embodiment, the tape portions can be folded into a z-shaped configuration.

In accordance with another embodiment of the present invention, a seam is provided that includes a first fabric piece and a second fabric piece. Each fabric piece has an upper surface and a lower surface that defines at least one edge. In addition, the seam comprises a first tape portion and a second tape portion that are adhesively and physically bonded to the first fabric piece and the second fabric piece, respectively.

In the connection method according to the invention, two textile pieces are laid one on the other, with an overlap, between a sonotrode and an anvil and are welded to one another ultrasonically. For this purpose, with the aid of suitable devices known to a person skilled in the art, the sonotrode is set in vibrations, the frequency of which is in the ultrasonic range. The textile pieces clamped between the sonotrode and the anvil functioning as a fixed counterpiece are thereby set in rapid movement, so that the thermoplastic fibres fuse or are plasticized and are connected to one another. This results in a connection of the textile pieces which is uniform over the entire surface.

The invention is based, in this case, on the knowledge that previous methods for the ultrasonic welding of textile pieces either did not offer sufficient strength or did not have sufficient processing properties. This problem is solved, according to the invention, in that the textile pieces are “cut off hot” at the margins of the regions to be connected to one another, that is to say a cut edge is formed such that the threads of the textile fabrics are essentially bound at the edge. It is known to a person skilled in the art that such an effect occurs, for example, as a result of ultrasonic cutting, but can also be achieved by other measures. It is critical that at least large proportions of the threads are bound at the edge, for example by plasticization.

The aim, here, is to form a weld seam at which plasticization of the synthetic fibres contained in the fabric takes place only at particular points, distributed as effectively as possible over the welding region. It has been shown that, in the case of high pressure and a long welding operation, large regions are plasticized, which may be undesirable with regard to the processing properties. In particular, these connections also become brittle, that is to say the textile character is lost.

According to the invention, the surfaces of the anvil and/or sonotrode are not smooth, but have a surface profile. By this is meant a pattern of elevations and depressions. By means of such a profile, the pressure is distributed in a suitable way and the material flow is influenced. As already mentioned, the aim is to maintain the textile character even at the weld. This is achieved by means of a number of locations, distributed over this region, at which plasticization occurs and individual threads are connected. It is preferred that these locations do not merge into one another, but that, between the plasticization locations, there are in each case still portions in which the fabric is still textile, that is to say is not plasticized. The plasticization locations should, as far as possible, be on the inside where the pieces to be connected lie one on the other.

A particularly preferred surface profile is a cross-grooved profile, in which pyramidal elevations arranged in rows and columns are applied closely next to one another on the surface of the anvil. The tips in this case define the locations at which plasticization first occurs.

Seaming apparatus of this type are known also as ultrasonic sewing machines though, for the avoidance of doubt, no needle and thread are used for providing a seam. Ultrasonic sewing machines are generally well known and comprise an ultrasonic horn operable to emit ultrasonic energy through a fabric/material engaging end face and a rotatable anvil support. The anvil support and the horn are arranged so as to define a “nip” between the respective fabric engaging surfaces thereof for receiving the fabric sheet materials (or components e.g. zipper fasteners) to be joined. Such apparatus is generally well known in the art and is described variously in for example, U.S. Pat. No. 3,852,144; WO 02/49831A1; U.S. Pat. No. 3,785,910; U.S. Pat. No. 3,666,599; and others.

In such known apparatus fabric material is fed through the apparatus utilising the rotary motion of the aforesaid anvil (or feed) wheel but such arrangements have two fundamental disadvantages. Firstly it has been found that the bearings in such anvil wheels, being in close proximity to a very high frequency (ultrasonic) source are liable to rapid degradation and wear (including also complete bearing failure) which can result in considerable machine downtime and loss of productivity. The second particular problem associated with known apparatus is that the material to be joined is “nipped” between the anvil/anvil wheel and the resonating horn more or less substantially continuously and it will be understood that where material to be joined is being fed through such apparatus, and being “nipped” thereby, it is difficult for an operator to guide material through such a machine in such a way that significant changes in direction of the material, as it is passed through the apparatus, can be realised, or intricate seams made. Yet a further disadvantage of known systems is that the movement of the material through known apparatus can result in the material puckering resulting in seams which are uneven and/or not adequately weatherproofed, or at worst are unsightly and require the garment to be rejected as sub standard.

It is an object of the present invention to avoid or minimise one or more of the foregoing disadvantages.

The present invention provides a seaming apparatus for joining, along a seam without thread, at least two superposed flexible sheet materials, said seaming apparatus comprising bonding means for bonding together at least two flexible sheet materials, said bonding means having a nip portion for releasably engaging together sheet material in use of the apparatus; and drive means formed and arranged for engaging sheet material, in use and to be bonded, and moving incrementally sheet material through said bonding means, said drive means being formed and arranged to co-operate with said nip portion so as to sequentially nip then drive material through the apparatus wherein only one of said nip portion and said drive means is in contact with sheet material, in use of the apparatus, at any given moment.

Thus with a seaming apparatus according to the present invention it is possible to feed sheet material to be seamed together through a machine and by virtue of the discontinuous nature of the drive means engaging the sheet material it is possible, for the first time, to achieve sharp angle changes in direction in a seam and/or to form intricate seam patterns.

Preferably said bonding means comprises an ultrasonic horn structure and a welding foot (or anvil), said horn and said welding foot (or anvil) comprising said nip portion. Alternatively there may be used a laser for bonding together said at least two superposed flexible sheet materials. Desirably where there is used a laser to bond together the material a layer of dye or other energy (radiation) absorbing material may be deposited onto the material so as to focus the laser energy to where the bonding is required. Energy absorbing materials may also be utilised in ultrasonic bonding.)

An example of a process for laser welding using a radiation absorbing material is the patented process of The Welding Institute, Cambridge disclosed in International Patent Publication No. WO 00/20157 known as the CLEARWELD™ technique.

The nip portion of the apparatus may further comprise a holding foot and a throat plate, said holding foot and said throat plate being formed and arranged for releasably engaging sheet material in use of the apparatus. This arrangement provides additional means of securely holding the sheet material in place during the bonding operation.

Preferably there is provided a pin portion formed and arranged to pinch the sheet material and thereby to enable a material (garment) to be pivoted round for easy maneuvering of the seam shape. The pin portion is desirably located in close proximity to the bonding means, preferably in alignment with the direction of feed and the bonding means. The pin portion may be conveniently attached to a moving foot of the drive means, or alternatively, can be independently mounted and actuated. The pin portion pinches the materials being joined, to hold them, at a time when they are not engaged by either the drive means or the bonding means, allowing the materials to be pivoted round to produce the desired seam shape or to correct the direction of the material through the apparatus. For some applications the pin of the pin portion may be pointed and can penetrate, or puncture, the materials to be bonded and thereby act as pivot point to facilitate the movement of material thereabout. For other applications, such as the production of water and windproof garments, it is desirable that the pin does not damage or puncture the sheet materials. In this case the pin has a contact surface at its tip that abuts and holds, but does not damage, the materials being joined when the pin portion pinches them. For example the contact surface at the tip of the pin may be a flat disc, or a hemisphere, having a sufficiently small surface area so as not to unduly impede pivoting of the pinched material therearound.

Preferably said bonding means is formed and arranged to provide a single discrete point of contact (bond) between said at least two superposed flexible sheet materials. In practice, and desirably, there may be provided a multiplicity of discrete points of contact between sheet materials where the thermoplastic constituents of such materials have fused and joined together. Advantageously said multiplicity of discrete joins or points of contact between flexible sheet materials provides a substantially continuous and weatherproof seam for an article or garment manufactured using said seaming apparatus. Alternatively the seam produced by said seaming apparatus can be considered to be a plurality of overlapping discrete welds or fusion points which have the appearance of a continuous seam.

Any suitable form of drive means may be used, which drive means releasably engages sheet material in use of the apparatus and for driving sheet material through said bonding means. The drive means may comprise a feed gear or gears or at least one feed dog formed and arranged to cooperate with at least one corresponding moving foot, between which flexible sheet material is engaged. Said feed dog is formed and arranged to incrementally move sheet material through the bonding means, then disengage the sheet material, return in an opposite direction to that in which it was engaging the sheet material and then re-engage a next portion of sheet material. Such a feed dog arrangement may be driven by a cam arrangement to produce the required cycle of motion. Stepper motors or the like may be used to drive said feed dog or said cam arrangement driving said feed dog. Preferably there are provided two moving feet co-operating with said feed dog.

Preferably said drive means is adjustable so as to vary the feed rate of the material through the seaming apparatus. Desirably the rate at which said nip portion of said bonding means “nips” is adjustable to correspond with any adjustments in the feed rate of the drive means, that is they are synchronised with one another. Desirably there is provided a controller means for co-ordinating operation of the drive means and the nip portion of the bonding means.

The points of contact, the contact faces, of the nip portion can be designed to impart various patterned appearances to the fabric, materials or components being joined.

The present invention also provides a method for joining, along a seam without thread, at least two superposed flexible sheet materials comprising the steps of;

a) providing a seaming apparatus according to the invention; and

b) introducing said at least two flexible sheet materials into said seaming apparatus whereby the flexible sheet materials are sequentially, nipped by the nip portion of the apparatus whilst being bonded by the bonding means, then driven incrementally through the apparatus by the drive means, with only one of said nip portion and said drive means being in contact with the sheet material at any given moment.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

I claim:

1. Seamless Headwear comprising:
a. At least one panel secured by ultrasonic sewing.

2. A headwear as in claim 1, whereas said headwear provides for ventilation.

3. A headwear as in claim 1, whereas said headwear is light weight.

4. A headwear as in claim 1, whereas said headwear is adjustable for various head sizes.

5. A method of manufacturing a seamless headwear with the following manufacturing process comprising:
a. selecting cloth material;
b. cutting out cut-out panel pieces with specific pattern outlines; and
c. using ultrasonic or high frequency processing art to administer heat processing on the edges of the superimposed cut-out pieces, thereby fusing the fiber material component.

6. The manufacturing method for a seamless headwear according to claim 5, wherein a bottom edge can be heat fused and joined or stitched to a hat brim.

7. The manufacturing method for a seamless headwear according to claim 5, wherein a bottom edge can be heat fused and joined or stitched to a sweatband liner.

8. The manufacturing method for a seamless headwear according to claim 5, wherein panel pieces may be formed with at least one layer of mesh.
